(19) United States
(12) Patent Application Publication
(10) Pub. No.: US 2011/0081547 A1
(43) Pub. Date: Apr. 7, 2011

(54) NATURAL QUICK-DRYING YARN AND A MANUFACTURING METHOD THEREOF

(75) Inventors: Chih-Chang Hsu, Taipei (TW); Shih-Ching Hung, Taipei (TW)

(73) Assignee: RUENTEX INDUSTRIES LIMITED, Taipei (TW)

(21) Appl. No.: 12/646,982

(22) Filed: Dec. 24, 2009

(30) Foreign Application Priority Data
Oct. 1, 2009 (TW) 098133455

(51) Int. Cl. D02G 3/36; B05D 3/02; B05D 3/12

(52) U.S. Cl. 428/378; 427/379; 427/382; 427/177

(57) ABSTRACT

A natural quick-drying yarn and a manufacturing method thereof are provided. The natural quick-drying yarn is made of a plurality of natural fibers. Hydrophobic agents are disposed between the natural fibers and on the surface of the natural fibers. Hydrophilic agents are disposed outside the natural fibers. The method includes immersing natural fibers in a solution of hydrophobic agent to dispose the hydrophobic agent between the natural fibers and on the surface of the natural fibers, drying the hydrophobic agent solution immersed natural fibers, immersing the natural fibers in a solution of hydrophilic agent to dispose the hydrophilic agent outside the natural fibers, and drying the hydrophilic agent solution immersed natural fibers.

### BACKGROUND OF THE INVENTION

1. Field of the Invention

This invention generally relates to a natural quick-drying yarn and a manufacturing method thereof. More particularly, the natural quick-drying yarn can be used to make a fabric.

2. Description of the Prior Art

Since human skin is smoother, clothes tend to cling to the skin surface of human body when the clothes absorb moisture or sweat coming through the skin. When wearing such wetting clothes, people may feel uncomfortable because of the wet and sticky feeling induced by the moisture or the sweat on the clothes. Therefore, there are some wet-absorbing/sweat-draining fabrics available on the market. Mostly, due to the fabric structural design, the conventional wet-absorbing/sweat-draining fabrics can vaporize the moisture on the fabrics into the air by the temperature difference between the human body and the ambient air. However, the manufacturing cost of conventional wet-absorbing/sweat-draining fabrics is relatively higher because of the special structure design.

Because sweat and filth easily permeate into natural fibers, fabrics made of natural fibers are much harder to be cleaned and the moisture thereon is more difficult to be vaporized. In contrast, although fabrics made of synthetic fibers do not have the above mentioned disadvantages, a cloth made by the synthetic fibers is less comfortable and is much easier to produce static electricity in a dry environment.

### SUMMARY OF THE INVENTION

It is an object of the present invention to provide a natural quick-drying yarn and a manufacturing method thereof, wherein the natural quick-drying yarn has a good filth-proof ability.

It is another object of the present invention to provide a natural quick-drying fabric and a manufacturing method thereof, wherein the natural quick-drying fabric has a good ability in water-draining and filth-proof.

The natural quick-drying yarn is made of a plurality of natural fibers, wherein hydrophobic agents are disposed between the natural fibers and on the surface of the natural fibers, and hydrophilic agents are disposed outside the natural fibers. The natural fibers are selected from a group consisting of plant fibers, animal fibers, mineral fibers, and a combination thereof. The hydrophobic agent can be selected from a group consisting of wax, sulphoisophthalic polymers, acrylic polymers, organosilicon, fluorine-containing polymers, and a combination thereof. The hydrophilic agent can be selected from a group consisting of cation type silicon, aminosilicon, nonionic type silicon, and a combination.

The method for manufacturing a natural quick-drying yarn which is made of a plurality of natural fibers includes immersing the natural fibers in a solution of hydrophobic agent to dispose the hydrophobic agent between the natural fibers and on the surface of the natural fibers; drying the hydrophobic agent solution immersed natural fibers; immersing the natural fibers in a solution of hydrophilic agent to dispose the hydrophilic agent outside the natural fibers; and drying the hydrophilic agent solution immersed natural fibers. The solution of hydrophilic agent further includes a permeating agent, wherein the permeating agent is selected from a group consisting of fatty acid derivatives, anion surfactants, alcohols, and a combination thereof.

The natural quick-drying yarn manufacturing method further includes refining the natural fibers before immersing the natural fibers in the solution of hydrophobic agent. The natural quick-drying yarn manufacturing method further includes bleaching the natural fibers before immersing the natural fibers in the solution of hydrophobic agent. The natural quick-drying yarn manufacturing method further includes dyeing the natural fibers before immersing the natural fibers in the solution of hydrophobic agent.

A natural quick-drying fabric is made of the natural quick-drying yarns. A natural quick-drying fabric manufacturing method includes winding a plurality of natural quick-drying yarns to form a winded yarn, wherein each natural quick-drying yarn includes a plurality of natural fibers; immersing the natural quick-drying yarns in a solution of hydrophobic agent to dispose the hydrophobic agent between the natural fibers and on the surface of the natural fibers; drying the hydrophobic agent solution immersed natural quick-drying yarns at a temperature between 30° C. and 180° C.; immersing the natural quick-drying yarns in a solution of hydrophilic agent to dispose the hydrophilic agent outside the natural quick-drying yarns; and drying the hydrophilic agent solution immersed natural quick-drying yarns. The solution of hydrophilic agent further includes a permeating agent. The permeating agent can be selected from a group consisting of fatty acid derivatives, anion surfactants, alcohols, and a combination thereof.

The natural quick-drying fabric manufacturing method further includes refining the natural quick-drying yarns before immersing the natural quick-drying yarns in the solution of hydrophobic agent. The natural quick-drying fabric manufacturing method further includes bleaching the natural quick-drying yarns before immersing the natural quick-drying yarns in the solution of hydrophobic agent. The natural quick-drying fabric manufacturing method further includes dyeing the natural quick-drying yarns before immersing the natural quick-drying yarns in the solution of hydrophobic agent. The natural quick-drying fabric manufacturing method further includes forming the natural quick-drying yarns into a greige before immersing the natural quick-drying yarns in the solution of hydrophobic agent. The greige forming step includes sizing the natural quick-drying yarns. The greige forming step includes weaving the natural quick-drying yarns. The natural quick-drying fabric manufacturing method further includes desizing the greige after the greige forming step. The greige desizing step includes immersing the greige in hot water at a temperature between 30° C. and 180° C. for 3 minutes to 60 minutes. The greige desizing step includes immersing the greige in an enzyme solution at a temperature between 30° C. and 70° C. for 3 minutes to 60 minutes.

### BRIEF DESCRIPTION OF THE DRAWINGS

FIG. 1 is a schematic view of an embodiment of the present invention;

FIG. 2 is a flow chart of an embodiment of the present invention;

FIG. 3 is a schematic view of one embodiment of the present invention; and

FIG. 4 is a flow chart of the embodiment of the present invention.

### DETAILED DESCRIPTION OF THE PREFERRED EMBODIMENT

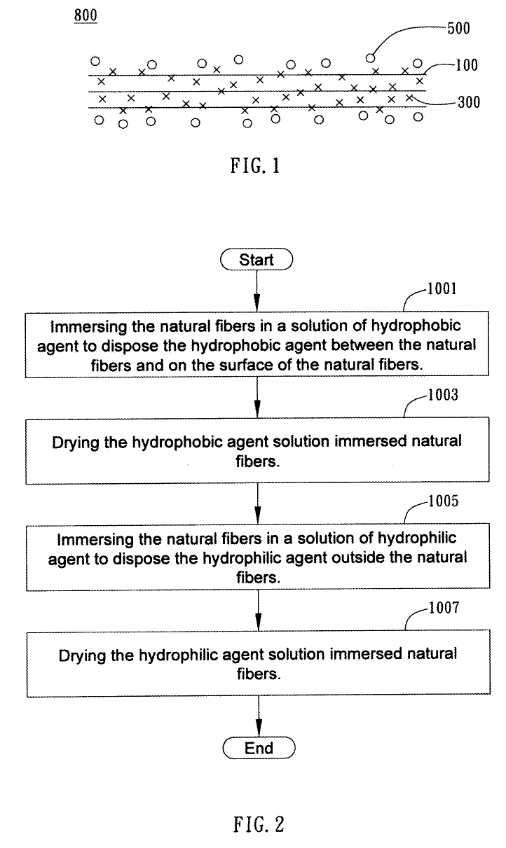

In the embodiment shown in FIG. 1, the natural quick-drying yarn 800 of the present invention is made of a plurality of natural fibers 100, wherein hydrophobic agents 300 are disposed between the natural fibers 100 and on the surface of the natural fibers 100, and hydrophilic agents 500 are disposed outside the natural fibers 100. Because hydrophobic agents 300 are disposed between the natural fibers 100 and on the surface of the natural fibers 100, it is not easy for hydrophilic filth to permeate into the natural quick-drying yarn 800. Therefore, the natural quick drying yarn 800 of the present invention has a good filth-proof ability.

The natural fibers can be selected from a group consisting of plant fibers, animal fibers, mineral fibers, and the combination thereof. The hydrophobic agents can be selected from a group consisting of wax, sulphoisophthalic polymers, acrylic polymers, organosilicon, fluorine-containing polymers, and the combination thereof. The hydrophilic agents can be selected from a group consisting of cation type silicon, aminosilicon, nonionic type silicon, and a combination thereof.

A flow chart of the natural quick-drying yarn manufacturing method of the present invention is shown in FIG. 2, wherein the natural quick-drying yarn manufacturing method includes the following steps.

Step 1001, a step of immersing the natural fibers in a solution of hydrophobic agent to dispose the hydrophobic agent between the natural fibers and on the surface of the natural fibers is performed.

Step 1003, a step of drying the hydrophobic agent solution immersed natural fibers is performed, wherein the hydrophobic agent solution immersed natural fibers can be dried at a temperature between 30° C. and 180° C. by hot air, infrared rays, or baking.

Step 1005, a step of immersing the natural fibers in a solution of hydrophilic agent to dispose the hydrophilic agent outside the natural fibers is performed.

Step 1007, a step of drying the hydrophilic agent solution immersed natural fibers is performed, wherein the hydrophilic agent solution immersed natural fibers may be dried at a temperature between 30° C. and 180° C. by hot air, infrared rays, or baking. The solution of hydrophilic agent may further include a permeating agent, wherein the permeating agent can be selected from a group consisting of fatty acid derivatives, anion surfactants, alcohols, and a combination thereof.

In different embodiments, the natural quick-drying yarn manufacturing method further includes refining, bleaching, or dyeing the natural fibers before the step of immersing the natural fibers in the solution of hydrophobic agent. The refining procedure is performed to remove natural impurities and residual grease or residual wax from the fibers by boiling with lye. The bleaching procedure is performed to remove dye and residual impurities by boiling with sodium hypochlorite or hydrogen peroxide solution.

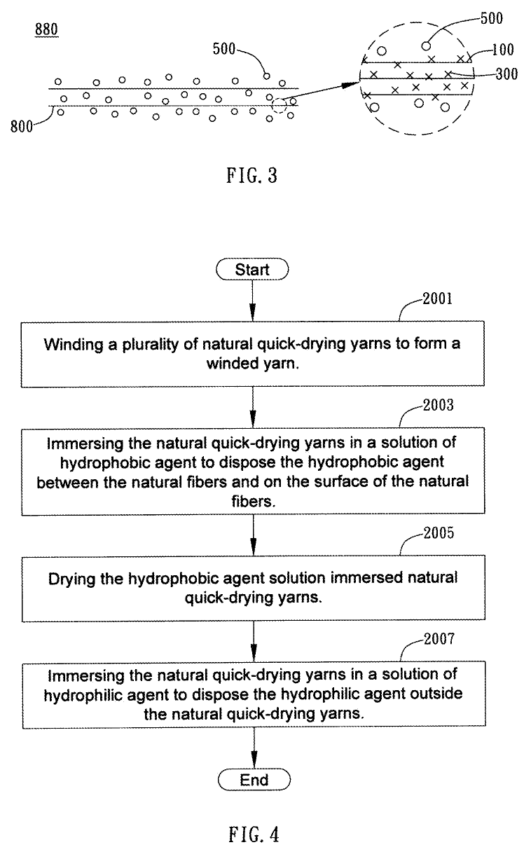

As shown in FIG. 3, the natural quick-drying fabric 880 of the present invention is made of the above mentioned natural quick-drying yarns 800. Hydrophilic agents 500 are disposed outside the natural fibers 100. In other words, hydrophilic agents are disposed between the natural quick-drying yarns 800. When water collides with part of the natural quick-drying yarns 800, it will spread out quickly because of the hydrophilic agents 500. Therefore, the natural quick-drying fabric 880 of the present invention has a good water-draining ability. On the other hand, the filth is not easy to permeate into the natural quick-drying yarns 800 because of the hydrophobic agents 300 disposed between the natural fibers 100 and on the surface of the natural fibers 100. In other words, take a cloth made by the natural quick-drying fabric 880 for example, the cloth can be cleaned more easily because the sweat is difficult to permeate into the natural quick-drying yarns 800 because of the hydrophobic agents 300 disposed between the natural fibers 100 and on the surface of the natural fibers 100. The sweat can spread out quickly because of the hydrophilic agents 500 to increase the vaporization of the sweat. Therefore, the natural quick-drying fabric 880 of the present invention has a good water-draining ability.

A flow chart of the natural quick-drying fabric manufacturing method of the present invention is shown in FIG. 2, wherein the natural quick-drying fabric manufacturing method includes the following steps.

Step 2001, a step of winding a plurality of natural quick-drying yarns to form a winded yarn is performed, wherein each natural quick-drying yarn includes a plurality of natural fibers.

Step 2003, a step of immersing the natural quick-drying yarns in a solution of hydrophobic agent to dispose the hydrophobic agent between the natural fibers and on the surface of the natural fibers is performed.

Step 2005, a step of drying the hydrophobic agent solution immersed natural quick-drying yarns is performed, wherein the hydrophobic agent solution immersed natural fibers is preferably dried at a temperature between 30° C. and 180° C. by hot air, infrared rays, or baking.

Step 2007, a step of immersing the natural quick-drying yarns in a solution of hydrophilic agent to dispose the hydrophilic agent outside the natural quick-drying yarns is performed.

Step 2005, a step of drying the hydrophilic agent solution immersed natural quick-drying yarns is performed, wherein the hydrophilic agent solution immersed natural fibers is preferably dried at a temperature between 30° C. and 180° C. by hot air, infrared rays, or baking.

The natural quick-drying fabric manufacturing method further includes refining, bleaching, dyeing, or forming the natural quick-drying yarns into a greige before immersing the natural quick-drying yarns in the solution of hydrophobic agent. The refining, bleaching, or dyeing steps are similar to those used in the natural quick-drying yarn and will not be elaborated hereinafter. The greige forming step includes sizing the natural quick-drying yarns. The greige forming step includes weaving the natural quick-drying yarns. The natural quick-drying fabric manufacturing method further includes desizing the greige after the greige forming step. A boiling solution of lye, oxidant, or enzyme can be used in desizing. The lye may include sodium hydroxide, sodium carbonate, etc. The oxidant may include a solution of hydrogen peroxide. The greige desizing step includes immersing the greige in hot water at a temperature between 30° C. and 180° C. for 3 minutes to 60 minutes. The greige desizing step includes immersing the greige in an enzyme solution at a temperature between 30° C. and 70° C. for 3 minutes to 60 minutes.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A natural quick-drying yarn is made of a plurality of natural fibers, wherein hydrophobic agents are disposed between the natural fibers and on the surface of the natural fibers, and hydrophilic agents are disposed outside the natural fibers.

2. The natural quick-drying yarn of claim 1, wherein the natural fibers are selected from a group consisting of plant fibers, animal fibers, mineral fibers, and a combination thereof.

3. A method for manufacturing a natural quick-drying yarn, wherein the natural quick-drying yarn is made of a plurality of natural fibers, the method comprising:
immersing the natural fibers in a solution of hydrophobic agent to dispose the hydrophobic agent between the natural fibers and on the surface of the natural fibers;
drying the hydrophobic agent solution immersed natural fibers;
immersing the natural fibers in a solution of hydrophilic agent to dispose the hydrophilic agent outside the natural fibers; and
drying the hydrophilic agent solution immersed natural fibers.

4. The method of claim 3, wherein the natural fibers are selected from a group consisting of plant fibers, animal fibers, mineral fibers, and a combination thereof.

5. The method of claim 3, wherein the hydrophobic agent solution immersed natural fibers are dried at a temperature of 30° C. to 180° C.

6. The method of claim 3, further comprising refining the natural fibers before the step of immersing the natural fibers in the solution of hydrophobic agent.

7. The method of claim 3, further comprising bleaching the natural fibers before the step of immersing the natural fibers in the solution of hydrophobic agent.

8. The method of claim 3, further comprising dyeing the natural fibers before the step of immersing the natural fibers in the solution of hydrophobic agent.

9. The method of claim 3, wherein the solution of hydrophilic agent further includes a permeating agent.

10. The method of claim 9, wherein the permeating agent is selected from a group consisting of fatty acid derivatives, anion surfactants, alcohols, and a combination thereof.

11. A natural quick-drying fabric is made of natural quick-drying yarns, wherein the natural quick-drying yarn includes a plurality of natural fibers, hydrophobic agents are disposed between the natural fibers and on the surface of the natural fibers, and hydrophilic agents are disposed outside the natural fibers.

12. The natural quick-drying fabric of claim 11, wherein the natural fibers are selected from a group consisting of plant fibers, animal fibers, mineral fibers, and a combination thereof.

13. A natural quick-drying fabric manufacturing method, comprising:
winding a plurality of natural quick-drying yarns to form a winded yarn, wherein each natural quick-drying yarn includes a plurality of natural fibers;
immersing the natural quick-drying yarns in a solution of hydrophobic agent to dispose the hydrophobic agent between the natural fibers and on the surface of the natural fibers;
drying the hydrophobic agent solution immersed natural quick-drying yarns;
immersing the natural quick-drying yarns in a solution of hydrophilic agent to dispose the hydrophilic agent outside the natural quick-drying yarns; and
drying the hydrophilic agent solution immersed natural quick-drying yarns.

14. The natural quick-drying fabric manufacturing method of claim 13, wherein the natural fibers are selected from a group consisting of plant fibers, animal fibers, mineral fibers, and a combination thereof.

15. The natural quick-drying fabric manufacturing method of claim 13, wherein the hydrophobic agent solution immersed natural quick-drying yarns are dried at a temperature of 30° C. to 180° C.

16. The natural quick-drying fabric manufacturing method of claim 13, further comprising refining the natural quick-drying yarns before the step of immersing the natural quick-drying yarns in the solution of hydrophobic agent.

17. The natural quick-drying fabric manufacturing method of claim 13, further comprising bleaching the natural quick-drying yarns before the step of immersing the natural quick-drying yarns in the solution of hydrophobic agent.

18. The natural quick-drying fabric manufacturing method of claim 13, further comprising dyeing the natural quick-drying yarns before the step of immersing the natural quick-drying yarns in the solution of hydrophobic agent.

19. The natural quick-drying fabric manufacturing method of claim 13, further comprising forming the natural quick-drying yarns into a greige before the step of immersing the natural quick-drying yarns in the solution of hydrophilic agent.

20. The natural quick-drying fabric manufacturing method of claim 19, wherein the solution of hydrophilic agent further includes a permeating agent.
